(19) United States
(12) Patent Application Publication
(10) Pub. No.: US 2025/0273654 A1
(43) Pub. Date: Aug. 28, 2025

(54) DUAL-METAL ELECTRODE FOR METAL-AIR BATTERY

(71) Applicant: NISSAN NORTH AMERICA, INC., Franklin, TN (US)

(72) Inventors: Mohammed Hussain ABDUL JABBAR, Novi, MI (US); Deepesh GOPALAKRISHNAN, Pontiac, MI (US)

(21) Appl. No.: 18/590,728

(22) Filed: Feb. 28, 2024

(51) Int. Cl. H01M 4/36; H01M 4/02; H01M 4/42; H01M 4/46; H01M 4/62

(52) U.S. Cl. CPC H01M 4/366; H01M 4/42; H01M 4/466; H01M 4/62; H01M 2004/027; H01M 2004/028; H01M 2300/0014

(57) ABSTRACT

An electrode is provided that includes a first layer formed of a first metal and a second layer provided on a surface of the first layer. The second layer is formed of a second metal. The first metal is selected from the group consisting of: zinc, aluminum and mixtures thereof, and the second metal is selected from the group consisting of: magnesium, iron and mixtures thereof. The second layer is a partial layer that does not completely cover the surface of the first layer.

### BACKGROUND

### Field of the Invention

The present invention generally relates to a dual-metal electrode for a metal-air battery, and a metal-air battery including the dual-metal electrode. The electrode includes a first layer formed of a first metal and a second layer formed of a second metal. The second layer is provided on a surface of the first layer. The first metal is selected from the group consisting of: zinc, aluminum and mixtures thereof, and the second metal is selected from the group consisting of: magnesium, iron and mixtures thereof. The second layer is a partial layer that does not completely cover the surface of the first layer.

### Background Information

Metal-air batteries that include metal anodes and use air as a cathode are desirable because they are safer than conventional batteries due to the possibility of using non-lithium metals that still have a high energy density. Therefore, metal-air batteries can generate a large amount of power with a relatively thin electrode structure, thus permitting a reduction in the size of the battery as compared with other conventional batteries including anodes made of carbon or silicon. In addition, metal-air batteries have a much higher energy efficiency than lithium-ion batteries that use lithium metal anodes and cathodes formed of complex oxides such as lithium nickel manganese cobalt oxide (LiNiMnCoO₂). Metal-air batteries are also cheaper due to the abundance of the metals used in the anode and are considered more environmentally friendly than lithium-ion batteries due to their good recyclability and the use of less toxic metals for the anode and anode catalysts.

However, there are several drawbacks with conventional metal-air batteries, which include highly reactive intermediates, high polarization, short cycle life, and inconsistent charge-discharge behavior which dampen the glory of this system. For example, the reversibility of conventional metal-air batteries is much lower than that of lithium-ion batteries. Unlike lithium-ion batteries, which allow reversible reactions, metal-air batteries often have one-way transfers of materials due to the products generated by the reaction of oxygen with the metal(s) in the anode. Furthermore, the rechargeability of conventional metal-air batteries is lower than that of lithium-ion batteries due to corrosion from the oxygen in the air and the resulting lower shelf life of these metal-air batteries. For example, conventional metal-air batteries only operate for approximately 200 cycles, whereas lithium-ion batteries can be operated for thousands of cycles. The harsh oxidative potential of conventional metal-air batteries can also cause irreversible damage to active sites at the cathode and electrochemical corrosion of the carbon support.

As a result of these problems, conventional metal-air batteries require specific engineering of the metallic anode in order to suppress the corrosion and nonuniform dissolution and deposition. Formation of a nonuniform passivation layer (i.e., a solid electrolyte interface) can also be another problem with these batteries. The performance of conventional metal-air batteries is also limited by current density because the anodes in such batteries are prone to excessive dendritic growth and accumulation of dead lithium resulting in severe volume expansion of the anodes. Over multiple charge and discharge cycles the formation of dendrites at the interface results in: reduced Li availability for the electrochemical reactions, disruption in Li transport through the interface and increased safety concerns due to short circuiting. Furthermore, the interface of the metal anode and the electrolyte has weak adhesion, resulting in peeling off of the anode from the electrolyte.

Therefore, further improvement is needed to sufficiently improve the rechargeability, durability and overall performance of the metal-air battery. In particular, it is desirable to increase the adhesion between the anode and the electrolyte and thereby decrease the ohmic resistance of the battery. It is also desirable to prevent excessive dendritic growth and formation of undesirable compounds caused by the reaction of the metallic anode with oxygen in the air.

### SUMMARY

It has been discovered that the adhesion between the anode and the electrolyte can be improved by providing a metal-air battery that includes a dual-metal anode in which one of the metals anchors the anode to the electrolyte. It has also been discovered that undesirable reactions between the oxygen in the air and the metallic anode can be reduced—thereby improving the rechargeability of the battery—by forming the anode of two metals—a first metal that includes zinc and/or aluminum and a second metal that includes magnesium and/or iron. It has further been discovered that the dual-metal anode can improve the safety and durability of the battery by reducing the formation of dendrites.

In particular, it has been discovered that the performance, safety and durability of a metal-air battery can be improved by providing a dual-metal anode in which one of the metals is formed of zinc and/or aluminum, the other metal is formed of magnesium and/or iron, and one of the metals is provided as a partial layer on the other metal. The synergistic effect of the two metals enhances the rechargeability of the battery by reducing the formation of undesirable products generated by reaction of the oxygen with the metal in the anode. Furthermore, by forming the anode of a non-lithium metal, dendrite growth can be prevented, thereby improving battery durability and safety.

It has also been discovered that the adhesion of the anode to the electrolyte can be improved by providing one of the metal layers in the dual-metal anode as a partial layer, thereby anchoring the anode to the electrolyte and preventing peeling off of the anode from the electrolyte. This in turn enhances the cyclability of the battery, lowers the internal resistance of the battery and improves the battery durability and performance. Therefore, it is desirable to provide a metal-air battery that includes such a dual-metal anode.

In view of the state of the known technology, one aspect of the present disclosure is to provide a dual-metal electrode for a metal-air battery. The electrode includes a first layer formed of a first metal and a second layer provided on a surface of the first layer. The second layer is formed of a second metal. The first metal is selected from the group consisting of: zinc, aluminum and mixtures thereof, and the second metal is selected from the group consisting of: magnesium, iron and mixtures thereof. The second layer is a partial layer that does not completely cover the surface of the first layer.

Another aspect of the present disclosure is to provide a metal-air battery including the dual-metal electrode. The battery includes a cathode, an anode, and an electrolyte disposed between the cathode and the anode. The anode includes a first layer formed of a first metal and a second layer provided on a surface of the first layer. The second layer is formed of a second metal. The first metal is selected from the group consisting of: zinc, aluminum and mixtures thereof, and the second metal is selected from the group consisting of: magnesium, iron and mixtures thereof. The second layer is a partial layer that does not completely cover the surface of the first layer.

By providing a dual-metal anode in which one of the metals is formed as a partial layer on the other metal, the adhesion between the electrolyte and the anode can be improved, thus preventing undesirable peeling off of the anode from the electrolyte and decreasing the resistance while improving the cyclability of the battery. Furthermore, by forming the anode of a first metal selected from the group consisting of: zinc, aluminum and mixtures thereof, and a second metal selected from the group consisting of: magnesium, iron and mixtures thereof, unwanted reactions between the oxygen and the metal of the anode can be reduced, thereby improving the rechargeability of the battery. In addition, by forming the dual-metal anode of non-lithium metals, dendrite growth can be prevented, thus improving the safety and performance of the battery. The synergistic effect of the two metals also improves the performance of the battery.

### BRIEF DESCRIPTION OF THE DRAWINGS

Referring now to the attached drawings which form a part of this original disclosure:

FIG. 1(a) is a top perspective view of a metal-air battery including a dual-metal anode according to one embodiment;

FIG. 1(b) is a top perspective view of the dual-metal anode of FIG. 1(a);

FIG. 2 is a top perspective view of a metal-air battery according to an embodiment;

FIG. 3 is a top perspective view of a metal-air battery according to one embodiment;

FIG. 4 is a top perspective view of a metal-air battery according to an embodiment;

FIG. 5 is a top perspective view of a metal-air battery according to an embodiment;

FIG. 6 is an illustrated flow chart showing a process of producing a metal-air battery having a dual-metal electrode according to one embodiment; and

FIG. 7 is an illustrated flow chart showing a process of producing a metal-air battery having a dual-metal electrode according to an embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

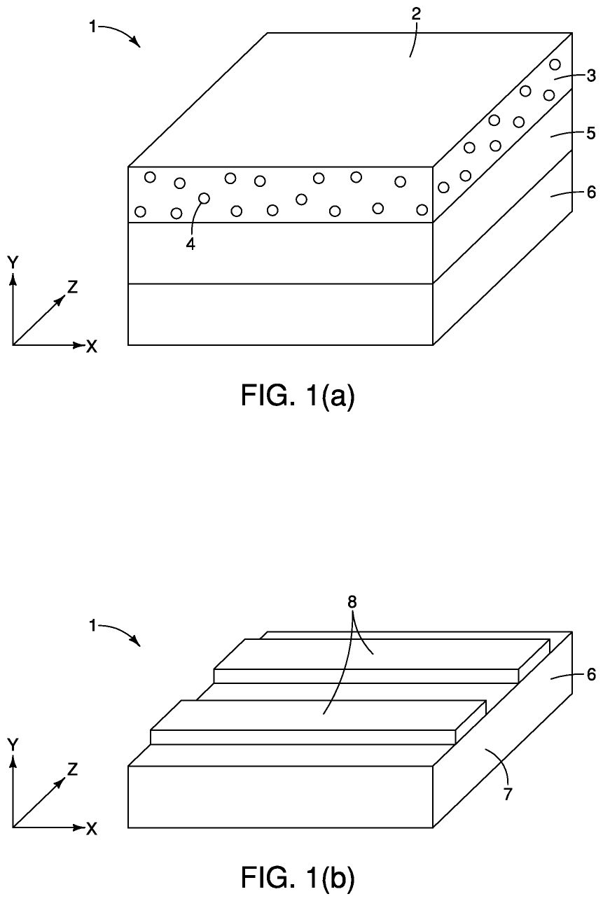

Referring initially to FIG. 1(a), a metal-air battery 1 is illustrated that includes a cathode 2, an electrolyte 5, and a dual-metal anode 6 in accordance with a first embodiment. The metal-air battery 1 can be incorporated in a vehicle, a mobile device, a laptop computer, an energy grid or any other suitable portable electronic device or stationary energy storage device. The metal-air battery 1 is preferably a zero-gap battery in which the electrodes and the electrolyte are in contact with each other with no space or gap therebetween.

As shown in FIG. 1(a), the cathode 2 includes a porous metal 3 and a catalyst 4 that is impregnated in the porous metal 3. The cathode 2 is formed as a gas diffusion layer that is configured to allow air to pass through the pores in the porous metal 3 so that the oxygen in the air can react with the metals in the dual-metal anode 6. The cathode 2 has a thickness ranging from 10 μm to 100 μm, preferably 12 μm.

The porous metal 3 is formed as a layer and can be any suitable porous metal for a metal-air battery. For example, the porous metal 3 can be formed of aluminum, titanium, copper or stainless steel. The porous metal 3 has three-dimensional pores and a porosity of approximately 30% to 50% by volume. The porous metal 3 is preferably formed of aluminum or stainless steel and is preferably formed as a metal mesh layer. The porous metal 3 has a thickness ranging from 10 μm to 100 μm, preferably 12 μm.

The catalyst 4 is provided as particles impregnated in the porous metal 3 as shown in FIG. 1(a). For example, the catalyst particles 4 are impregnated into the pores of the porous metal 3 by liquid-phase impregnation. However, it should be understood that the catalyst particles 4 can be impregnated in the porous metal 3 in any suitable manner. The catalyst particles 4 are provided in an amount of 5% by weight to 10% by weight of the total weight of the metal-air battery 1. The catalyst particles 4 can be formed of any suitable catalyst for a cathode of a metal-air battery. For example, the catalyst particles 4 can be formed of at least one of: ruthenium oxide, an alloy comprising platinum, graphene, lanthanum strontium cobaltite, lanthanum strontium manganese chromite and samarium strontium cobaltite. The catalyst particles 4 are preferably formed of ruthenium oxide doped with manganese. The catalyst particles 4 have a size or diameter of approximately 50 nm to 500 nm.

The electrolyte 5 is any suitable electrolyte for a metal-air battery, such as a solid electrolyte or a polymer electrolyte. The electrolyte 5 can be any suitable mesoporous electrolyte. For example, the electrolyte 5 can be a ceramic-based or polymer-based mesoporous material that holds an electrolyte liquid in the mesopores. The mesoporous material can be a ceramic such as SrTiO₃, LaTiO₃ or stabilized ZrO₂, or the mesoporous material can be a polymer material such as Teflon. The mesoporous material has a porosity of approximately 5% to 20% by volume and includes mesopores each having a diameter or size of approximately 2 nm to 50 nm for liquid retention in the mesopores.

The electrolyte liquid can be any suitable electrolyte liquid for a metal-air battery and depends on the chemistry of the metal-air battery 1. For example, the electrolyte liquid can be potassium hydroxide (KOH), sodium hydroxide (NaOH), zinc acetate, zinc chloride, dimethyl sulfoxide (“DMSO”), ethanol or any mixture thereof. The electrolyte liquid held in the mesopores of the electrolyte 5 is preferably KOH, NaOH or a mixture thereof. The electrolyte 5 has a thickness of approximately 10 μm to 100 μm, preferably 20 μm.

The electrolyte 5 can also include an optional binder for processing. When aqueous KOH is used as the electrolyte liquid, no binder is required. The binder can be any suitable binder for an electrolyte of a metal-air battery. For example, when other gel or polymer electrolytes are used, the binder can be polyvinyl alcohol, polyacrylic acid or polyvinylidene fluoride (“PVDF”).

As shown in FIG. 1(b), the dual-metal anode 6 includes a first metal layer 7 and a second metal layer 8 that is provided on the top surface of the first metal layer 7 such that the second metal layer 8 is provided between the first metal layer 7 and the electrolyte 5. The dual-metal anode 6 has a total thickness of approximately 2 μm to 40 μm, preferably 10 μm.

The first metal layer 7 is formed of a first metal that includes zinc, aluminum or a mixture of zinc and aluminum. The first metal is preferably formed entirely of zinc. The first metal layer 7 is formed as a layer having a substantially flat and planar surface. The first metal layer 7 has a thickness of approximately 1 μm to 20 μm, preferably 5 μm.

The first metal layer 7 can also include an additive and/or a binder in addition to the first metal. The first metal layer 7 includes approximately 90-95 percent by weight of the first metal and five to ten percent by weight of the additive plus the binder. The binder can be any suitable electrode binder material. For example, the binder can include PVDF, polyvinyl alcohol, polyacrylic acid or any combination thereof. The additive can be any suitable sacrificial electrode additive.

As shown in FIG. 1(b), the second metal layer 8 is provided on the top surface of the first metal layer 7 facing the electrolyte 5. The second metal layer 8 is formed as a plurality of strips having a greater length in the X-direction than in the Z-direction on the top surface of the first metal layer 7 as shown in FIG. 1(b). The strips 8 extend the entire length of the first metal layer 7 in the X-direction and are spaced apart from each other at regular intervals. The strips 8 are spaced apart from each other by a distance of approximately 1 μm to 20 μm, preferably 5 μm. The strips 8 are preferably spaced apart from each other at a distance equal to the thickness of the second metal layer 8.

However, it should be understood that the second metal layer 8 can have any suitable form on the top surface of the first metal layer 7, as long as the second metal layer 8 does not entirely cover the top surface of the first metal layer 7. For example, the second metal layer 8 can be formed as strips having a greater length in the Z-direction than in the X-direction. The second metal layer 8 can also be formed as a single strip or a plurality of strips that are spaced apart from each other at irregular intervals. Alternatively, the second metal layer 8 can be formed as discrete islands having a square, rectangular or circular shape on the top surface of the first metal layer 7.

The second metal layer 8 is formed of a second metal that includes magnesium, iron or a mixture of magnesium and iron. The second metal is preferably formed entirely of magnesium. The second metal layer 8 has a thickness of approximately 1 μm to 20 μm, preferably 5 μm.

The second metal layer 8 can also include an additive and/or a binder in addition to the second metal. The second metal layer 8 includes approximately 90-95 percent by weight of the second metal and five to ten percent by weight of the additive plus the binder. The binder can be any suitable electrode binder material. For example, the binder can include PVDF, polyvinyl alcohol, polyacrylic acid or any combination thereof. The additive can be any suitable sacrificial electrode additive.

The second metal layer 8 can be formed on the first metal layer 7 in any suitable manner. For example, the second metal layer 8 can be formed by melting or sintering a layer including the second metal on the top surface of the first metal layer 7, then performing laser etching or chemical etching of the layer including the second metal to form the strips 8. Alternatively, the second metal layer 8 can be formed by first performing laser or chemical etching on the top surface of the first metal layer 7 to form grooves or holes and then depositing a layer including the second metal in the grooves or holes on the top surface of the first metal layer 7.

By providing the dual-metal electrode 6 in which the second metal layer 8 is formed as a partial layer on the first metal layer 7, the adhesion between the electrolyte 5 and the anode 6 can be improved by anchoring the anode 6 to the electrolyte 5, thus preventing undesirable peeling off of the anode 6 from the electrolyte 5 and decreasing the resistance while improving the cyclability of the metal-air battery 1. Furthermore, by forming the anode 6 of the first metal and the second metal, unwanted reactions between the oxygen and the metal of the anode can be reduced, thereby improving the rechargeability of the battery. In addition, by forming the dual-metal anode 6 of non-lithium metals such as zinc, aluminum, magnesium or iron as described above, dendrite growth can be prevented, thus improving the safety and performance of the metal-air battery 1. The synergistic effect of the two metals, in particular when the first metal is zinc and the second metal is magnesium, also improves the performance of the metal-air battery 1.

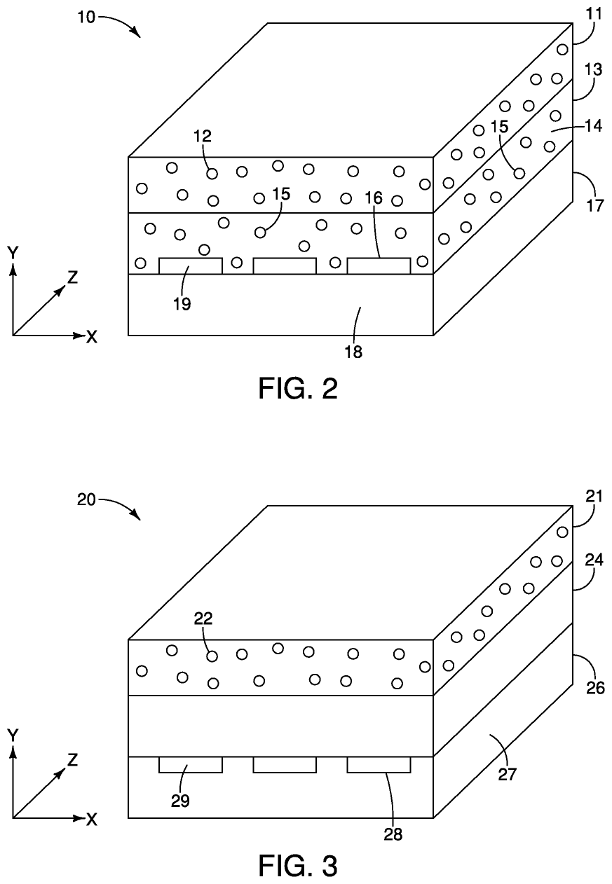

FIG. 2 shows a metal-air battery 10 in accordance with a second embodiment. The metal-air battery 10 includes a cathode 11, an electrolyte 13, and a dual-metal anode 17. As with the first embodiment, the metal-air battery 10 of the second embodiment can be incorporated in a vehicle, a mobile device, a laptop computer, an energy grid or any other suitable portable electronic device or stationary energy storage device. The metal-air battery 10 is preferably a zero-gap battery in which the electrodes and the electrolyte are in contact with each other with no space or gap therebetween.

The cathode 11 includes a porous metal and a catalyst 12 impregnated in the porous metal. The cathode 11 is formed as a gas diffusion layer that is configured to allow air to pass through the pores in the porous metal so that the oxygen in the air can react with the metals in the dual-metal anode 17. The cathode 11 has a thickness ranging from 10 μm to 100 μm, preferably 12 μm.

The porous metal is formed as a layer and can be any suitable porous metal for a metal-air battery. For example, the porous metal can be formed of aluminum, titanium, copper or stainless steel. The porous metal has three-dimensional pores and a porosity of approximately 30% to 50% by volume. The porous metal is preferably formed of aluminum or stainless steel and is preferably formed as a metal mesh layer. The porous metal has a thickness ranging from 10 μm to 100 μm, preferably 12 μm.

The catalyst 12 is preferably provided as particles impregnated in the porous metal. However, it should be understood that the catalyst 12 can be impregnated in the porous metal in any suitable manner. The catalyst 12 is provided in an amount of 5% by weight to 10% by weight of the total weight of the metal-air battery 10. The catalyst particles 12 can be formed of any suitable catalyst for a cathode of a metal-air battery. For example, the catalyst particles 12 can be formed of at least one of: ruthenium oxide, an alloy comprising platinum, graphene, lanthanum strontium cobaltite, lanthanum strontium manganese chromite and samarium strontium cobaltite. The catalyst particles 12 are preferably formed of ruthenium oxide doped with manganese. The catalyst particles 12 have a size or diameter of approximately 50 nm to 500 nm.

As shown in FIG. 2, the electrolyte 13 includes a mesoporous material 14 that holds an electrolyte material 15 in the mesopores. The electrolyte 13 is any suitable electrolyte for a metal-air battery, such as a solid electrolyte or a polymer electrolyte. The electrolyte 13 has a thickness of approximately 10 μm to 100 μm, preferably 20 μm.

The mesoporous material 14 can be a ceramic such as SrTiO₃, LaTiO₃ or stabilized ZrO₂, or the mesoporous material 14 can be a polymer material such as Teflon. The mesoporous material 14 has a porosity of approximately 5% to 20% by volume and includes mesopores each having a diameter or size of approximately 2 nm to 50 nm for retention of the electrolyte material 15 in the mesopores. The mesoporous material 14 has a thickness of approximately 10 μm to 100 μm, preferably 20 μm.

The electrolyte material 15 can be any suitable electrolyte for a metal-air battery and depends on the chemistry of the metal-air battery 10. The electrolyte material 15 is preferably a liquid. For example, the liquid can be potassium hydroxide (KOH), sodium hydroxide (NaOH), zinc acetate, zinc chloride, DMSO, ethanol or any mixture thereof. The liquid held in the mesopores of the electrolyte 13 is preferably KOH, NaOH or a mixture thereof.

The electrolyte 13 can also include an optional binder for processing. When aqueous KOH is used as the electrolyte liquid, no binder is required. The binder can be any suitable binder for an electrolyte of a metal-air battery. For example, when other gel or polymer electrolytes are used, the binder can be polyvinyl alcohol, polyacrylic acid or PVDF.

The electrolyte 13 also includes a plurality of grooves 16 as shown in FIG. 2. The grooves 16 are spaced apart from each other in the X-direction by a distance of approximately 1 μm to 20 μm, preferably 5 μm. The grooves 16 are formed in a strip shape on the bottom surface of the electrolyte 13 and extend along the entire length of the electrolyte 13 in the Z-direction. However, it should be understood that the grooves 16 can have any suitable form designed to complement or accommodate the shape of the dual-metal electrode 17. For example, the grooves 16 can be formed as discrete recesses or grooves separated from each other in both the X- and Z-directions.

As shown in FIG. 2, the dual-metal anode 17 includes a first metal layer 18 and a second metal layer 19 that is provided on the top surface of the first metal layer 18 such that the second metal layer 19 is provided within the grooves 16 of the electrolyte 13 and between the first metal layer 18 and the electrolyte 13. The dual-metal anode 17 has a total thickness of approximately 2 μm to 40 μm, preferably 10 μm.

The first metal layer 18 is formed of a first metal that includes zinc, aluminum or a mixture of zinc and aluminum. The first metal is preferably formed entirely of zinc. The first metal layer 18 is formed as a layer having a substantially flat and planar surface. The first metal layer 18 has a thickness of approximately 1 μm to 20 μm, preferably 5 μm.

The first metal layer 18 can also include an additive and/or a binder in addition to the first metal. The first metal layer 18 includes approximately 90-95 percent by weight of the first metal and five to ten percent by weight of the additive plus the binder. The binder can be any suitable electrode binder material. For example, the binder can include PVDF, polyvinyl alcohol, polyacrylic acid or any combination thereof. The additive can be any suitable sacrificial electrode additive.

As shown in FIG. 2, the second metal layer 19 is provided on the top surface of the first metal layer 18 and within the grooves 16 of the electrolyte 13. The second metal layer 19 is formed as a plurality of strips having a greater length in the Z-direction than in the X-direction on the top surface of the first metal layer 19 as shown in FIG. 2. The strips 19 extend the entire length of the first metal layer 18 in the Z-direction and the entire length of the grooves 16 in the Z-direction. The strips 19 are spaced apart from each other at regular intervals. The strips 19 are preferably spaced apart from each other by a distance of approximately 1 μm to 20 μm, preferably 5 μm. The strips 19 are preferably spaced apart from each other at a distance equal to the thickness of the second metal layer 19.

Although in this embodiment, the second metal layer 19 entirely fills the grooves 16 of the electrolyte 13, it should be understood that the second metal layer 19 can have any suitable form on the top surface of the first metal layer 18, as long as the second metal layer 19 does not entirely cover the top surface of the first metal layer 18. For example, the second metal layer 19 can be formed as strips having a greater length in the X-direction than in the Z-direction. The second metal layer 19 can also be formed as a single strip or a plurality of strips that are spaced apart from each other at irregular intervals. Alternatively, the second metal layer 19 can be formed as discrete islands having a square, rectangular or circular shape on the top surface of the first metal layer 18. The grooves 16 of the electrolyte 13 are preferably formed to have a shape that complements or surrounds each of the structures that form the second metal layer 19. However, the grooves 16 can be formed in the strip shape within the electrolyte 13 and the second metal layer 19 can be formed so as to only partially fill the grooves 16 of the electrolyte 13.

The second metal layer 19 is formed of a second metal that includes magnesium, iron or a mixture of magnesium and iron. The second metal is preferably formed entirely of magnesium. The second metal layer 19 has a thickness of approximately 1 μm to 20 μm, preferably 5 μm.

The second metal layer 19 can also include an additive and/or a binder in addition to the second metal. The second metal layer 19 includes approximately 90-95 percent by weight of the second metal and five to ten percent by weight of the additive plus the binder. The binder can be any suitable electrode binder material. The binder can be any suitable electrode binder material. For example, the binder can include PVDF, polyvinyl alcohol, polyacrylic acid or any combination thereof. The additive can be any suitable sacrificial electrode additive.

The second metal layer 19 can be formed on the first metal layer 18 in any suitable manner. For example, the second metal layer 19 can be formed by melting or sintering a layer including the second metal on the top surface of the first metal layer 18, then performing laser etching or chemical etching of the layer including the second metal to form the strips 19. Alternatively, the second metal layer 19 can be formed by first performing laser or chemical etching on the top surface of the first metal layer 18 to form grooves or holes and then depositing a layer including the second metal in the grooves or holes on the top surface of the first metal layer 18.

FIG. 3 shows a metal-air battery 20 in accordance with a third embodiment. The metal-air battery 20 includes a cathode 21, an electrolyte 24, and a dual-metal anode 26. As with the first and second embodiments, the metal-air battery 20 of the third embodiment can be incorporated in a vehicle, a mobile device, a laptop computer, an energy grid or any other suitable portable electronic device or stationary energy storage device. The metal-air battery 20 is preferably a zero-gap battery in which the electrodes and the electrolyte are in contact with each other with no space or gap therebetween.

The cathode 21 includes a porous metal and a catalyst 22 impregnated in the porous metal. The cathode 21 is formed as a gas diffusion layer that is configured to allow air to pass through the pores in the porous metal so that the oxygen in the air can react with the metals in the dual-metal anode 26. The cathode 21 has a thickness ranging from 10 μm to 100 μm, preferably 12 μm.

The porous metal is formed as a layer and can be any suitable porous metal for a metal-air battery. For example, the porous metal can be formed of aluminum, titanium, copper or stainless steel. The porous metal has three-dimensional pores and a porosity of approximately 30% to 50% by volume. The porous metal is preferably formed of aluminum or stainless steel and is preferably formed as a metal mesh layer. The porous metal has a thickness ranging from 10 μm to 100 μm, preferably 12 μm.

The catalyst 22 is preferably provided as particles impregnated in the porous metal. However, it should be understood that the catalyst 22 can be impregnated in the porous metal in any suitable manner. The catalyst 22 is provided in an amount of 5% by weight to 10% by weight of the total weight of the metal-air battery 20. The catalyst particles 22 can be formed of any suitable catalyst for a cathode of a metal-air battery. For example, the catalyst particles 22 can be formed of at least one of: ruthenium oxide, an alloy comprising platinum, graphene, lanthanum strontium cobaltite, lanthanum strontium manganese chromite and samarium strontium cobaltite. The catalyst particles 22 are preferably formed of ruthenium oxide doped with manganese. The catalyst particles 22 have a size or diameter of approximately 50 nm to 500 nm.

The electrolyte 24 is any suitable electrolyte for a metal-air battery, such as a solid electrolyte or a polymer electrolyte. The electrolyte 24 can be any suitable mesoporous electrolyte. For example, the electrolyte 24 can be a ceramic-based or polymer-based mesoporous material that holds an electrolyte liquid in the mesopores. The mesoporous material can be a ceramic such as SrTiO₃, LaTiO₃ or stabilized ZrO₂, or the mesoporous material can be a polymer material such as Teflon. The mesoporous material has a porosity of approximately 5% to 20% by volume and includes mesopores each having a diameter or size of approximately 2 nm to 50 nm for liquid retention in the mesopores.

The electrolyte liquid can be any suitable electrolyte liquid for a metal-air battery and depends on the chemistry of the metal-air battery 20. For example, the electrolyte liquid can be potassium hydroxide (KOH), sodium hydroxide (NaOH), zinc acetate, zinc chloride, DMSO, ethanol or any mixture thereof. The electrolyte liquid held in the mesopores of the electrolyte 24 is preferably KOH, NaOH or a mixture thereof. The electrolyte 24 has a thickness of approximately 10 μm to 100 μm, preferably 20 μm.

The electrolyte 24 can also include an optional binder for processing. When aqueous KOH is used as the electrolyte liquid, no binder is required. The binder can be any suitable binder for an electrolyte of a metal-air battery. For example, when other gel or polymer electrolytes are used, the binder can be polyvinyl alcohol, polyacrylic acid or PVDF.

As shown in FIG. 3, the dual-metal anode 26 includes a first metal layer 27 having grooves 28 formed therein, and a second metal layer 29 that is provided within the grooves 28 of the first metal layer 27 and in contact with the electrolyte 24. The dual-metal anode 26 has a total thickness of approximately 2 μm to 40 μm, preferably 10 μm.

The first metal layer 27 is formed of a first metal that includes zinc, aluminum or a mixture of zinc and aluminum. The first metal is preferably formed entirely of zinc. The first metal layer 27 is formed as a layer having a substantially flat and planar surface with grooves 28 formed therein. As shown in FIG. 3, the grooves 28 of the first metal layer 27 are provided as strips that extend the entire length of the first metal layer in the Z-direction and are spaced apart from each other by a distance of approximately 1 μm to 20 μm, preferably 5 μm. The first metal layer 27 has a thickness of approximately 1 μm to 20 μm, preferably 5 μm.

The first metal layer 27 can also include an additive and/or a binder in addition to the first metal. The first metal layer 27 includes approximately 90-95 percent by weight of the first metal and five to ten percent by weight of the additive plus the binder. The binder can be any suitable electrode binder material. For example, the binder can include PVDF, polyvinyl alcohol, polyacrylic acid or any combination thereof. The additive can be any suitable sacrificial electrode additive.

As shown in FIG. 3, the second metal layer 29 is provided within the grooves 28 of the first metal layer 27. The second metal layer 29 is formed as a plurality of strips having a greater length in the Z-direction than in the X-direction on the top surface of the first metal layer 27 as shown in FIG. 3. The strips 29 extend the entire length of the first metal layer 27, and the grooves 28, in the Z-direction. The strips 29 are spaced apart from each other at regular intervals. The strips 29 are preferably spaced apart from each other by a distance of approximately 1 μm to 20 μm, preferably 5 μm. The strips 19 are preferably spaced apart from each other at a distance equal to the thickness of the second metal layer 29.

Although in this embodiment, the second metal layer 29 entirely fills the grooves 28 of the first metal layer 27, it should be understood that the second metal layer 29 can have any suitable form on the top surface of the first metal layer 27, as long as the second metal layer 29 does not entirely cover the top surface of the first metal layer 27. For example, the second metal layer 29 can be formed so as to only partially fill the grooves 28 of the first metal layer 27. Alternatively, the second metal layer 29 can be formed as strips having a greater length in the X-direction than in the Z-direction. The second metal layer 29 can also be formed as a single strip or a plurality of strips that are spaced apart from each other at irregular intervals. Alternatively, the second metal layer 29 can be formed as discrete islands having a square, rectangular or circular shape on the top surface of the first metal layer 27.

The second metal layer 29 is formed of a second metal that includes magnesium, iron or a mixture of magnesium and iron. The second metal is preferably formed entirely of magnesium. The second metal layer 29 has a thickness of approximately 1 μm to 20 μm, preferably 5 μm.

The second metal layer 29 can also include an additive and/or a binder in addition to the second metal. The second metal layer 29 includes approximately 90-95 percent by weight of the second metal and five to ten percent by weight of the additive plus the binder. The binder can be any suitable electrode binder material. For example, the binder can include PVDF, polyvinyl alcohol, polyacrylic acid or any combination thereof. The additive can be any suitable sacrificial electrode additive.

The second metal layer 29 can be formed on the first metal layer 27 in any suitable manner. For example, the second metal layer 29 can be formed by first performing laser or chemical etching on the top surface of the first metal layer 27 to form the grooves 27 and then depositing a layer including the second metal in the grooves or holes on the top surface of the first metal layer 27.

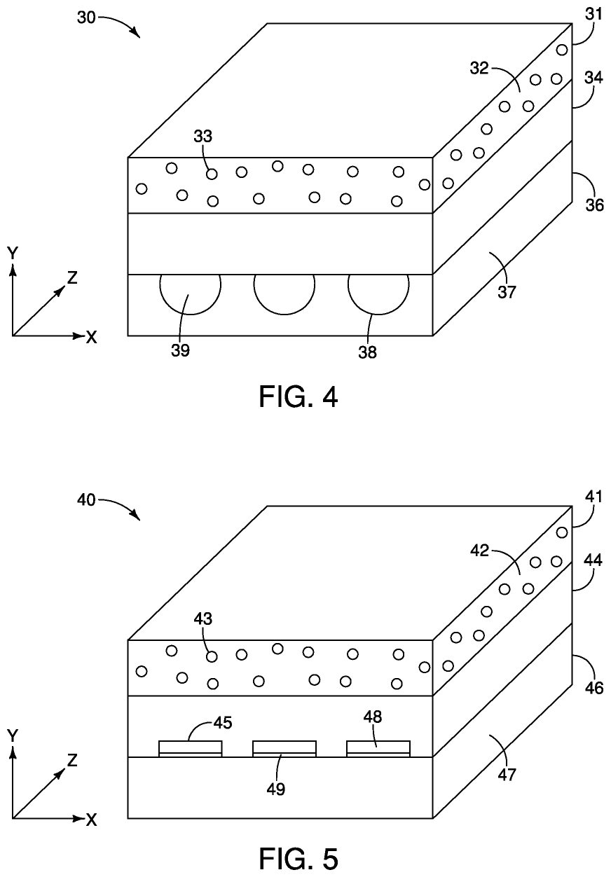

FIG. 4 shows a metal-air battery 30 in accordance with a fourth embodiment. The metal-air battery 30 includes a cathode 31, an electrolyte 34, and a dual-metal anode 36. As with the first, second and third embodiments, the metal-air battery 30 of the fourth embodiment can be incorporated in a vehicle, a mobile device, a laptop computer, an energy grid or any other suitable portable electronic device or stationary energy storage device. The metal-air battery 30 is preferably a zero-gap battery in which the electrodes and the electrolyte are in contact with each other with no space or gap therebetween.

The cathode 31 includes a porous metal 32 and a catalyst 33 impregnated in the porous metal. The cathode 31 is formed as a gas diffusion layer that is configured to allow air to pass through the pores in the porous metal so that the oxygen in the air can react with the metals in the dual-metal anode 36. The cathode 31 has a thickness ranging from 10 μm to 100 μm, preferably 12 μm.

The porous metal 32 is formed as a layer and can be any suitable porous metal for a metal-air battery. For example, the porous metal 32 can be formed of aluminum, titanium, copper or stainless steel. The porous metal 32 has three-dimensional pores and a porosity of approximately 30% to 50% by volume. The porous metal 32 is preferably formed of aluminum or stainless steel and is preferably formed as a metal mesh layer. The porous metal 32 has a thickness ranging from 10 μm to 100 μm, preferably 12 μm.

The catalyst 33 is preferably provided as particles impregnated in the porous metal. However, it should be understood that the catalyst 33 can be impregnated in the porous metal in any suitable manner. The catalyst 33 is provided in an amount of 5% by weight to 10% by weight of the total weight of the metal-air battery 30. The catalyst particles 33 can be formed of any suitable catalyst for a cathode of a metal-air battery. For example, the catalyst particles 33 can be formed of at least one of: ruthenium oxide, an alloy comprising platinum, graphene, lanthanum strontium cobaltite, lanthanum strontium manganese chromite and samarium strontium cobaltite. The catalyst particles 33 are preferably formed of ruthenium oxide doped with manganese. The catalyst particles 33 have a size or diameter of approximately 50 nm to 500 nm.

The electrolyte 34 is any suitable electrolyte for a metal-air battery, such as a solid electrolyte or a polymer electrolyte. The electrolyte 34 can be any suitable mesoporous electrolyte. For example, the electrolyte 34 can be a ceramic-based or polymer-based mesoporous material that holds an electrolyte liquid in the mesopores. The mesoporous material can be a ceramic such as SrTiO₃, LaTiO₃ or stabilized ZrO₂, or the mesoporous material can be a polymer material such as Teflon. The mesoporous material has a porosity of approximately 5% to 20% by volume and includes mesopores each having a diameter or size of approximately 2 nm to 50 nm for liquid retention in the mesopores.

The electrolyte liquid can be any suitable electrolyte liquid for a metal-air battery and depends on the chemistry of the metal-air battery 30. For example, the electrolyte liquid can be potassium hydroxide (KOH), sodium hydroxide (NaOH), zinc acetate, zinc chloride, DMSO, ethanol or any mixture thereof. The electrolyte liquid held in the mesopores of the electrolyte 34 is preferably KOH, NaOH or a mixture thereof. The electrolyte 34 has a thickness of approximately 10 μm to 100 μm, preferably 20 μm.

The electrolyte 34 can also include an optional binder for processing. When aqueous KOH is used as the electrolyte liquid, no binder is required. The binder can be any suitable binder for an electrolyte of a metal-air battery. For example, when other gel or polymer electrolytes are used, the binder can be polyvinyl alcohol, polyacrylic acid or PVDF.

As shown in FIG. 4, the dual-metal anode 36 includes a first metal layer 37 having grooves or recesses 38 formed therein, and a second metal layer 39 that is provided within the grooves 38 and in contact with the electrolyte 34. The dual-metal anode 36 has a total thickness of approximately 2 μm to 40 μm, preferably 10 μm.

The first metal layer 37 is formed of a first metal that includes zinc, aluminum or a mixture of zinc and aluminum. The first metal is preferably formed entirely of zinc. The first metal layer 37 is formed as a layer having a substantially flat and planar surface with grooves 38 formed therein. As shown in FIG. 4, the grooves 38 of the first metal layer 37 are provided as semi-circular grooves that extend the entire length of the first metal layer 37 in the Z-direction and are spaced apart from each other by a distance of approximately 1 μm to 20 μm, preferably 5 μm. The first metal layer 37 has a thickness of approximately 1 μm to 20 μm, preferably 5 μm.

The first metal layer 37 can also include an additive and/or a binder in addition to the first metal. The first metal layer 37 includes approximately 90-95 percent by weight of the first metal and five to ten percent by weight of the additive plus the binder. The binder can be any suitable electrode binder material. For example, the binder can include PVDF, polyvinyl alcohol, polyacrylic acid or any combination thereof. The additive can be any suitable sacrificial electrode additive.

As shown in FIG. 4, the second metal layer 39 is provided within the grooves 38 of the first metal layer 37. The second metal layer 39 is formed as a plurality of semi-circular strips having a greater length in the Z-direction than in the X-direction on the top surface of the first metal layer 37 as shown in FIG. 4. The strips 39 extend the entire length of the first metal layer 37, and the grooves 38, in the Z-direction. However, it should be understood that the strips 39 may not extend the entire length of the first metal layer 37 or the grooves 38. The strips 39 are spaced apart from each other at regular intervals. The strips 39 are preferably spaced apart from each other by a distance of approximately 1 μm to 20 μm, preferably 5 μm. The strips 39 are preferably spaced apart from each other at a distance equal to the thickness of the second metal layer 39.

Although in this embodiment, the second metal layer 39 entirely fills the grooves 38 of the first metal layer 37, it should be understood that the second metal layer 39 can have any suitable form on the top surface of the first metal layer 37, as long as the second metal layer 39 does not entirely cover the top surface of the first metal layer 37. For example, the second metal layer 39 can be formed so as to only partially fill the grooves 38 of the first metal layer 37. Alternatively, the second metal layer 39 can be formed as strips having a greater length in the X-direction than in the Z-direction. The second metal layer 39 can also be formed as a single strip or a plurality of strips that are spaced apart from each other at irregular intervals. Alternatively, the second metal layer 39 can be formed as discrete islands having a square, rectangular or circular shape on the top surface of the first metal layer 37.

The second metal layer 39 is formed of a second metal that includes magnesium, iron or a mixture of magnesium and iron. The second metal is preferably formed entirely of magnesium. The second metal layer 39 has a thickness of approximately 1 μm to 20 μm, preferably 5 μm.

The second metal layer 39 can also include an additive and/or a binder in addition to the second metal. The second metal layer 39 includes approximately 90-95 percent by weight of the second metal and five to ten percent by weight of the additive plus the binder. The binder can be any suitable electrode binder material. For example, the binder can include PVDF, polyvinyl alcohol, polyacrylic acid or any combination thereof. The additive can be any suitable sacrificial electrode additive.

The second metal layer 39 can be formed on the first metal layer 37 in any suitable manner. For example, the second metal layer 39 can be formed by first performing laser or chemical etching on the top surface of the first metal layer 37 to form the semi-circular grooves 38 and then depositing a layer including the second metal in the grooves or holes on the top surface of the first metal layer 37.

FIG. 5 shows a metal-air battery 40 in accordance with a fifth embodiment. The metal-air battery 40 includes a cathode 41, an electrolyte 44, and a dual-metal anode 46. As with the first through fourth embodiments, the metal-air battery 40 of the fifth embodiment can be incorporated in a vehicle, a mobile device, a laptop computer, an energy grid or any other suitable portable electronic device or stationary energy storage device. The metal-air battery 40 is preferably a zero-gap battery in which the electrodes and the electrolyte are in contact with each other with no space or gap therebetween.

The cathode 41 includes a porous metal 42 and a catalyst 43 impregnated in the porous metal. The cathode 41 is formed as a gas diffusion layer that is configured to allow air to pass through the pores in the porous metal so that the oxygen in the air can react with the metals in the dual-metal anode 46. The cathode 41 has a thickness ranging from 10 μm to 100 μm, preferably 12 μm.

The porous metal 42 is formed as a layer and can be any suitable porous metal for a metal-air battery. For example, the porous metal 42 can be formed of aluminum, titanium, copper or stainless steel. The porous metal 42 has three-dimensional pores and a porosity of approximately 30% to 50% by volume. The porous metal 42 is preferably formed of aluminum or stainless steel and is preferably formed as a metal mesh layer. The porous metal 42 has a thickness ranging from 10 μm to 100 μm, preferably 12 μm.

The catalyst 43 is preferably provided as particles impregnated in the porous metal. However, it should be understood that the catalyst 43 can be impregnated in the porous metal in any suitable manner. The catalyst 43 is provided in an amount of 5% by weight to 10% by weight of the total weight of the metal-air battery 40. The catalyst particles 43 can be formed of any suitable catalyst for a cathode of a metal-air battery. For example, the catalyst particles 43 can be formed of at least one of: ruthenium oxide, an alloy comprising platinum, graphene, lanthanum strontium cobaltite, lanthanum strontium manganese chromite and samarium strontium cobaltite. The catalyst particles 43 are preferably formed of ruthenium oxide doped with manganese. The catalyst particles 43 have a size or diameter of approximately 50 nm to 500 nm.

The electrolyte 44 is any suitable electrolyte for a metal-air battery, such as a solid electrolyte or a polymer electrolyte. The electrolyte 44 can be any suitable mesoporous electrolyte. For example, the electrolyte 44 can be a ceramic-based or polymer-based mesoporous material that holds an electrolyte liquid in the mesopores. The mesoporous material can be a ceramic such as SrTiO₃, LaTiO₃ or stabilized ZrO₂, or the mesoporous material can be a polymer material such as Teflon. The mesoporous material has a porosity of approximately 5% to 20% by volume and includes mesopores each having a diameter or size of approximately 2 nm to 50 nm for liquid retention in the mesopores.

The electrolyte liquid can be any suitable electrolyte liquid for a metal-air battery and depends on the chemistry of the metal-air battery 40. For example, the electrolyte liquid can be potassium hydroxide (KOH), sodium hydroxide (NaOH), zinc acetate, zinc chloride, DMSO, ethanol or any mixture thereof. The electrolyte liquid held in the mesopores of the electrolyte 44 is preferably KOH, NaOH or a mixture thereof. The electrolyte 44 has a thickness of approximately 10 μm to 100 μm, preferably 20 μm.

The electrolyte 44 can also include an optional binder for processing. When aqueous KOH is used as the electrolyte liquid, no binder is required. The binder can be any suitable binder for an electrolyte of a metal-air battery. For example, when other gel or polymer electrolytes are used, the binder can be polyvinyl alcohol, polyacrylic acid or PVDF.

The electrolyte 44 also includes a plurality of grooves 45 as shown in FIG. 5. The grooves 45 are spaced apart from each other in the X-direction a distance of approximately 1 μm to 20 μm, preferably 5 μm. The grooves 45 are formed in a strip shape on the bottom surface of the electrolyte 44 and extend along the entire length of the electrolyte 44 in the Z-direction. However, it should be understood that the grooves 45 can have any suitable form designed to complement or accommodate the shape of the dual-metal electrode 46. For example, the grooves 45 can be formed as discrete recesses or grooves separated from each other in both the X- and Z-directions.

As shown in FIG. 5, the dual-metal anode 46 includes a first metal layer 47 and a second metal layer 48 that is provided on the top surface of the first metal layer 47 such that the second metal layer 48 is provided within the grooves 45 of the electrolyte 44 and between the first metal layer 47 and the electrolyte 44. The dual-metal anode 46 has a total thickness of approximately 2 μm to 40 μm, preferably 10 μm.

The first metal layer 47 is formed of a first metal that includes zinc, aluminum or a mixture of zinc and aluminum. The first metal is preferably formed entirely of zinc. The first metal layer 47 is formed as a layer having a substantially flat and planar surface. The first metal layer 47 has a thickness of approximately 1 μm to 20 μm, preferably 5 μm.

The first metal layer 47 can also include an additive and/or a binder in addition to the first metal. The first metal layer 47 includes approximately 90-95 percent by weight of the first metal and five to ten percent by weight of the additive plus the binder. The binder can be any suitable electrode binder material. For example, the binder can include PVDF, polyvinyl alcohol, polyacrylic acid or any combination thereof. The additive can be any suitable sacrificial electrode additive.

As shown in FIG. 5, the second metal layer 48 is provided on the top surface of the first metal layer 47 and within the grooves 45 of the electrolyte 44. The second metal layer 48 is formed as a plurality of strips having a greater length in the Z-direction than in the X-direction on the top surface of the first metal layer 47 as shown in FIG. 5. The strips 48 extend the entire length of the first metal layer 47 in the Z-direction and the entire length of the grooves 45 in the Z-direction. The strips 48 are spaced apart from each other at regular intervals. The strips 48 are preferably spaced apart from each other by a distance of approximately 1 μm to 20 μm, preferably 5 μm. The strips 48 are preferably spaced apart from each other at a distance equal to the thickness of the second metal layer 48.

Although in this embodiment, the second metal layer 48 entirely fills the grooves 45 of the electrolyte 44, it should be understood that the second metal layer 48 can have any suitable form on the top surface of the first metal layer 47, as long as the second metal layer 48 does not entirely cover the top surface of the first metal layer 47. For example, the second metal layer 48 can be formed as strips having a greater length in the X-direction than in the Z-direction. The second metal layer 48 can also be formed as a single strip or a plurality of strips that are spaced apart from each other at irregular intervals. Alternatively, the second metal layer 48 can be formed as discrete islands having a square, rectangular or circular shape on the top surface of the first metal layer 47. The grooves 45 of the electrolyte 44 are preferably formed to have a shape that complements or surrounds each of the structures that form the second metal layer 48. However, the grooves 45 can be formed in the strip shape within the electrolyte 44 and the second metal layer 48 can be formed so as to only partially fill the grooves 45 of the electrolyte 44.

The second metal layer 48 is formed of a second metal that includes magnesium, iron or a mixture of magnesium and iron. The second metal is preferably formed entirely of magnesium. The second metal layer 48 has a thickness of approximately 1 μm to 20 μm, preferably 5 μm.

The second metal layer 48 can also include an additive and/or a binder in addition to the second metal. The second metal layer 48 includes approximately 90-95 percent by weight of the second metal and five to ten percent by weight of the additive plus the binder. The binder can be any suitable electrode binder material. For example, the binder can include PVDF, polyvinyl alcohol, polyacrylic acid or any combination thereof. The additive can be any suitable sacrificial electrode additive.

The second metal layer 48 can be formed on the first metal layer 47 in any suitable manner. For example, the second metal layer 48 can be formed by melting or sintering a layer including the second metal on the top surface of the first metal layer 18, then performing laser etching or chemical etching of the layer including the second metal to form the strips 19. Alternatively, the second metal layer 19 can be formed by first performing laser or chemical etching on the top surface of the first metal layer 18 to form grooves or holes and then depositing a layer including the second metal in the grooves or holes on the top surface of the first metal layer 18.

As shown in FIG. 5, an alloy layer 49 is formed between the first metal layer 47 and the second metal layer 48. The alloy layer 49 is formed of an alloy of the first metal from the first metal layer 47 and the second metal from the second metal layer 48. The alloy layer 49 is preferably formed of an alloy of zinc and magnesium. The alloy layer 49 can be formed in any suitable manner but is typically formed as a reaction of the first metal and the second metal if the second metal layer 48 is sintered on the first metal layer 47. The alloy layer 49 has a thickness of approximately 0.2 μm to 5 μm, preferably 5 μm.

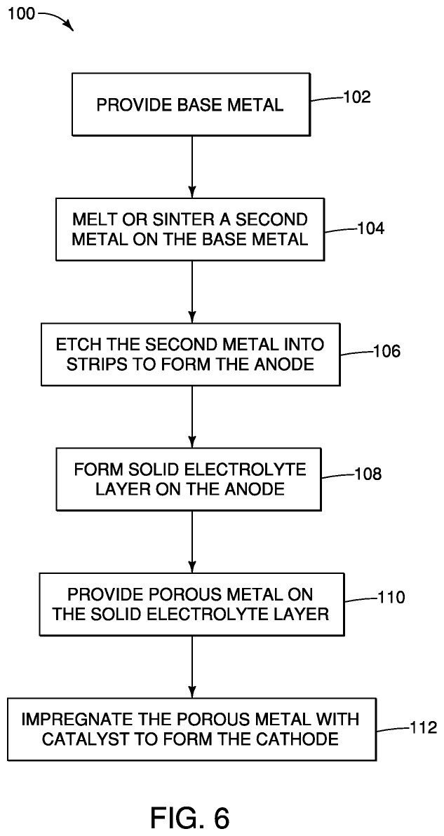

FIG. 6 illustrates a process 100 of producing a metal-air battery having a dual-metal electrode in accordance with a sixth embodiment. The metal-air battery produced according to the sixth embodiment can be incorporated in a vehicle, a mobile device, a laptop computer, an energy grid or any other suitable portable electronic device or stationary energy storage device. The metal-air battery is preferably a zero-gap battery in which the electrodes and the electrolyte are in contact with each other with no space or gap therebetween.

In Step 102, a base metal is provided. The base metal is formed of a first metal that includes zinc, aluminum or a mixture of zinc and aluminum. The base metal is preferably formed entirely of zinc. The base metal is formed as a layer having a substantially flat and planar surface. The base metal has a thickness of approximately 1 μm to 20 μm, preferably 5 μm.

The base metal can also include an additive and/or a binder in addition to the first metal. The base metal includes approximately 90-95 percent by weight of the first metal and five to ten percent by weight of the additive plus the binder. The binder can be any suitable electrode binder material. For example, the binder can include PVDF, polyvinyl alcohol, polyacrylic acid or any combination thereof. The additive can be any suitable sacrificial electrode additive.

In Step 104, a second metal is melted or sintered onto the base metal to bond the base metal and the second metal. The sintering can be performed at any suitable temperature above the melting points of the base metal and the second metal. For example, the sintering or melting can be performed at a temperature of approximately 200° C. to 1000° C., preferably 600° C.

The second metal is formed of a second metal that includes magnesium, iron or a mixture of magnesium and iron. The second metal is preferably formed entirely of magnesium. The second metal has a thickness of approximately 1 μm to 20 μm, preferably 5 μm.

The second metal can also include an additive and/or a binder in addition to the second metal. The second metal includes approximately 90-95 percent by weight of the second metal and five to ten percent by weight of the additive plus the binder. The binder can be any suitable electrode binder material. For example, the binder can include PVDF, polyvinyl alcohol, polyacrylic acid or any combination thereof. The additive can be any suitable sacrificial electrode additive.

In Step 106, the second metal is etched to form strips of the second metal on the base metal such that the second metal does not entirely cover the base metal and at least a portion of the base metal is exposed. The resulting structure of the second metal strips on the base metal forms the anode. The strips are spaced apart from each other at regular intervals. The strips are preferably spaced apart from each other by a distance of approximately 1 μm to 20 μm, preferably 5 μm. The strips are preferably spaced apart from each other at a distance equal to the thickness of the second metal strips. The resulting structure of the second metal strips on the base metal forms the anode.

In Step 108, a solid electrolyte layer is formed on the anode. The solid electrolyte can be any suitable mesoporous solid electrolyte. For example, the solid electrolyte can be a ceramic-based mesoporous material that holds an electrolyte liquid in the mesopores. The mesoporous material can be a ceramic such as SrTiO₃, LaTiO₃ or stabilized ZrO₂. The mesoporous material has a porosity of approximately 5% to 20% by volume and includes mesopores each having a diameter or size of approximately 2 nm to 50 nm for liquid retention in the mesopores.

The electrolyte liquid can be any suitable electrolyte liquid for a metal-air battery and depends on the chemistry of the metal-air battery. For example, the electrolyte liquid can be potassium hydroxide (KOH), sodium hydroxide (NaOH), zinc acetate, zinc chloride, DMSO, ethanol or any mixture thereof. The electrolyte liquid held in the mesopores of the solid electrolyte is preferably KOH, NaOH or a mixture thereof. The solid electrolyte has a thickness of approximately 10 μm to 100 μm, preferably 20 μm.

The solid electrolyte can also include an optional binder for processing. When aqueous KOH is used as the electrolyte liquid, no binder is required. The binder can be any suitable binder for an electrolyte of a metal-air battery. For example, when other gel or polymer electrolytes are used, the binder can be polyvinyl alcohol, polyacrylic acid or PVDF.

The solid electrolyte can be formed on the anode in any suitable manner. For example, the solid electrolyte can be formed by physical or chemical deposition on the anode. Alternatively, when the solid electrolyte is formed of a ceramic material, the ceramic material can be sintered onto the anode at a temperature of approximately 800° C. to 1300° C., preferably 1100° C.

In Step 110, a porous metal is provided on the solid electrolyte. The porous metal is a gas diffusion layer configured to allow air to pass through the pores in the porous metal so that oxygen in the air can react with the metals in the anode. The porous metal can be any suitable porous metal for a metal-air battery. For example, the porous metal can be formed of aluminum, titanium, copper or stainless steel, preferably aluminum or stainless steel. The porous metal has three-dimensional pores and a porosity of approximately 30% to 50% by volume. The porous metal is preferably formed as a metal mesh layer. The porous metal has a thickness ranging from 10 μm to 100 μm, preferably 12 μm.

In Step 112, the porous metal of Step 110 is impregnated with a catalyst to form the cathode. The resulting cathode, the solid electrolyte and the anode form the metal-air battery of the sixth embodiment. The catalyst is preferably provided as particles impregnated in the porous metal. However, it should be understood that the catalyst can be impregnated in the porous metal in any suitable manner. The catalyst is provided in an amount of 5% by weight to 10% by weight of the total weight of the metal-air battery. The catalyst particles can be formed of any suitable catalyst for a cathode of a metal-air battery. For example, the catalyst particles can be formed of at least one of: ruthenium oxide, an alloy comprising platinum, graphene, lanthanum strontium cobaltite, lanthanum strontium manganese chromite and samarium strontium cobaltite. The catalyst particles are preferably formed of ruthenium oxide doped with manganese. The catalyst particles have a size or diameter of approximately 50 nm to 500 nm.

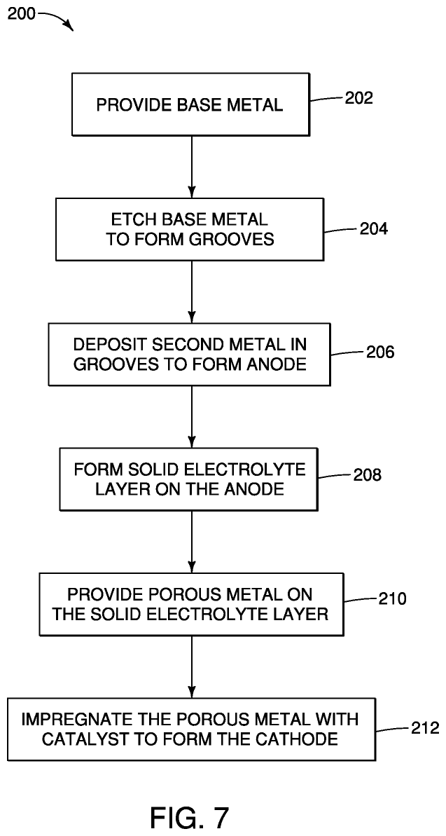

FIG. 7 illustrates a process 200 of producing a metal-air battery having a dual-metal electrode in accordance with a seventh embodiment. The metal-air battery can be incorporated in a vehicle, a mobile device, a laptop computer, an energy grid or any other suitable portable electronic device or stationary energy storage device. The metal-air battery is preferably a zero-gap battery in which the electrodes and the electrolyte are in contact with each other with no space or gap therebetween.

In Step 202, a base metal is provided. The base metal is formed of a first metal that includes zinc, aluminum or a mixture of zinc and aluminum. The base metal is preferably formed entirely of zinc. The base metal is formed as a layer having a substantially flat and planar surface. The base metal has a thickness of approximately 1 μm to 20 μm, preferably 5 μm.

The base metal can also include an additive and/or a binder in addition to the first metal. The base metal includes approximately 90-95 percent by weight of the first metal and five to ten percent by weight of the additive plus the binder. The binder can be any suitable electrode binder material. For example, the binder can include PVDF, polyvinyl alcohol, polyacrylic acid or any combination thereof. The additive can be any suitable sacrificial electrode additive.

In Step 204, the base metal is etched to form grooves therein. The grooves in the base metal can be formed by laser or chemical etching on the top surface of the base metal. The grooves can be formed to have a strip shape that extends along an entire length of the base metal, and the grooves can be spaced apart from each other. The grooves are preferably spaced apart from each other by a distance of approximately 1 μm to 20 μm, preferably 5 μm. Alternatively, the grooves can be formed as discrete holes or recesses in the base metal.

In Step 206, a second metal is deposited in the grooves of the base metal to form a dual-metal anode including the first metal and the second metal. The resulting structure of the second metal strips on the base metal forms the dual-metal anode. The strips are spaced apart from each other at regular intervals.

The second metal is formed of a second metal that includes magnesium, iron or a mixture of magnesium and iron. The second metal is preferably formed entirely of magnesium. The second metal has a thickness of approximately 1 μm to 20 μm, preferably 5 μm.

The second metal can also include an additive and/or a binder in addition to the second metal. The second metal includes approximately 90-95 percent by weight of the second metal and five to ten percent by weight of the additive plus the binder. The binder can be any suitable electrode binder material. For example, the binder can include PVDF, polyvinyl alcohol, polyacrylic acid or any combination thereof. The additive can be any suitable sacrificial electrode additive.

In Step 208, a solid electrolyte layer is formed on the dual-metal anode. The solid electrolyte can be any suitable mesoporous solid electrolyte. For example, the solid electrolyte can be a ceramic-based mesoporous material that holds an electrolyte liquid in the mesopores. The mesoporous material can be a ceramic such as SrTiO₃, LaTiO₃ or stabilized ZrO₂. The mesoporous material has a porosity of approximately 5% to 20% by volume and includes mesopores each having a diameter or size of approximately 2 nm to 50 nm for liquid retention in the mesopores.

The electrolyte liquid can be any suitable electrolyte liquid for a metal-air battery and depends on the chemistry of the metal-air battery. For example, the electrolyte liquid can be potassium hydroxide (KOH), sodium hydroxide (NaOH), zinc acetate, zinc chloride, DMSO, ethanol or any mixture thereof. The electrolyte liquid held in the mesopores of the solid electrolyte is preferably KOH, NaOH or a mixture thereof. The solid electrolyte has a thickness of approximately 10 μm to 100 μm, preferably 20 μm.

The solid electrolyte can also include an optional binder for processing. When aqueous KOH is used as the electrolyte liquid, no binder is required. The binder can be any suitable binder for an electrolyte of a metal-air battery. For example, when other gel or polymer electrolytes are used, the binder can be polyvinyl alcohol, polyacrylic acid or PVDF.

The solid electrolyte can be formed on the anode in any suitable manner. For example, the solid electrolyte can be formed by physical or chemical deposition on the anode. Alternatively, when the solid electrolyte is formed of a ceramic material, the ceramic material can be sintered onto the anode at a temperature of approximately 800° C. to 1300° C., preferably 1100° C.

In Step 210, a porous metal is provided on the solid electrolyte. The porous metal is a gas diffusion layer configured to allow air to pass through the pores in the porous metal so that oxygen in the air can react with the metals in the anode. The porous metal can be any suitable porous metal for a metal-air battery. For example, the porous metal can be formed of aluminum, titanium, copper or stainless steel, preferably aluminum or stainless steel. The porous metal has three-dimensional pores and a porosity of approximately 30% to 50% by volume. The porous metal is preferably formed as a metal mesh layer. The porous metal has a thickness ranging from 10 μm to 100 μm, preferably 12 μm.

In Step 212, the porous metal of Step 210 is impregnated with a catalyst to form the cathode. The resulting cathode, the solid electrolyte and the anode form the metal-air battery of the sixth embodiment. The catalyst is preferably provided as particles impregnated in the porous metal. However, it should be understood that the catalyst can be impregnated in the porous metal in any suitable manner.

The catalyst is provided in an amount of 5% by weight to 10% by weight of the total weight of the metal-air battery. The catalyst particles can be formed of any suitable catalyst for a cathode of a metal-air battery. For example, the catalyst particles can be formed of at least one of: ruthenium oxide, an alloy comprising platinum, graphene, lanthanum strontium cobaltite, lanthanum strontium manganese chromite and samarium strontium cobaltite. The catalyst particles are preferably formed of ruthenium oxide doped with manganese. The catalyst particles have a size or diameter of approximately 50 nm to 500 nm.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having” and their derivatives. Also, the terms “part,” “section,” “portion,” or “element” when used in the singular can have the dual meaning of a single part or a plurality of parts.

The terms of degree, such as “approximately” or “substantially” as used herein, mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. An electrode comprising:
a first layer formed of a first metal; and
a second layer provided on a surface of the first layer, the second layer being formed of a second metal,
the first metal being selected from the group consisting of: zinc, aluminum and mixtures thereof,
the second metal being selected from the group consisting of: magnesium, iron and mixtures thereof, and
the second layer being a partial layer that does not completely cover the surface of the first layer.

2. The electrode according to claim 1, wherein
the second layer is provided on the surface of the first layer in a form of at least one strip formed of the second metal.

3. The electrode according to claim 1, further comprising an alloy layer provided between the first layer and the second layer, the alloy layer comprising an alloy of the first metal and the second metal.

4. The electrode according to claim 1, wherein
the first layer comprises at least one groove formed therein, and the second layer is provided in the at least one groove of the first layer.

5. The electrode according to claim 4, wherein
the at least one groove comprises a plurality of grooves each formed in a strip shape, and the second layer is provided in each of the plurality of grooves.

6. The electrode according to claim 1, wherein
the first metal comprises zinc.

7. The electrode according to claim 1, wherein
the second metal comprises magnesium.

8. A battery comprising a cathode;
an anode; and
an electrolyte disposed between the cathode and the anode,
the anode comprising:
a first layer formed of a first metal; and
a second layer provided on a surface of the first layer, the second layer being formed of a second metal,
the first metal being selected from the group consisting of: zinc, aluminum and mixtures thereof,
the second metal being selected from the group consisting of: magnesium, iron and mixtures thereof, and
the second layer being a partial layer that does not completely cover the surface of the first layer.

9. The battery according to claim 8, wherein
the second layer is provided on the surface of the first layer in a form of at least one strip formed of the second metal.

10. The battery according to claim 8, further comprising
an alloy layer provided between the first layer and the second layer, the alloy layer comprising an alloy of the first metal and the second metal.

11. The battery according to claim 8, wherein
the first layer comprises at least one groove formed therein, and the second layer is provided in the at least one groove of the first layer.

12. The battery according to claim 8, wherein
the first metal comprises zinc.

13. The battery according to claim 8, wherein
the second metal comprises magnesium.

14. The battery according to claim 8, wherein
the cathode comprises a porous metal impregnated with a catalyst.

15. The battery according to claim 14, wherein
the catalyst comprises at least one selected from the group consisting of: ruthenium oxide, an alloy comprising platinum, graphene, lanthanum strontium cobaltite, lanthanum strontium manganese chromite and samarium strontium cobaltite.

16. The battery according to claim 14, wherein
the catalyst comprises ruthenium oxide doped with manganese.

17. The battery according to claim 8, wherein
the electrolyte comprises a hydroxide selected from the group consisting of: potassium hydroxide, sodium hydroxide and lithium hydroxide.

18. The battery according to claim 17, wherein
the electrolyte comprises a mesoporous ceramic material that holds the hydroxide within mesopores.

19. The battery according to claim 8, wherein
the electrolyte comprises at least one groove, and the second layer is provided within the at least one groove.

20. The battery according to claim 8, wherein
the second layer is in contact with the electrolyte.
